(19) United States
(12) Patent Application Publication
(10) Pub. No.: US 2023/0018454 A1
(43) Pub. Date: Jan. 19, 2023

(54) OPTICAL MODULE AND LASER SYSTEM

(71) Applicant: FOCUSLIGHT TECHNOLOGIES INC., Xi'an (CN)

(72) Inventors: Lei CAI, Xi'an (CN); Xingsheng LIU, Xi'an (CN)

(21) Appl. No.: 17/849,603

(22) Filed: Jun. 25, 2022

(30) Foreign Application Priority Data
Jul. 13, 2021 (CN) 202110787127.2

(51) Int. Cl. G02B 3/02

(52) U.S. Cl. CPC G02B 3/02; G02B 2003/0093

(57) ABSTRACT

The invention discloses an optical module and a laser system, and relates to the technical field of optics. The optical module comprises a first light emitting assembly, a second light emitting assembly, and a homogenizing lens group arranged on the light emitting sides of the first light emitting assembly and the second light emitting assembly; Light beams emitted by the first light emitting assembly and the second light emitting assembly are respectively and vertically incident on the light incident side of the homogenizing lens group, and the homogenizing lens group homogenizes and emits the light beams incident by the first light emitting assembly and the second light emitting assembly to form light spots. The optical module and the laser system are small and compact in structure, and can realize diversified forms of output light spots, so that the optical module and the laser system can meet different requirements.

### FIELD

The invention relates to the technical field of optics, particularly an optical module and a laser system.

### BACKGROUND

The semiconductor laser is used as one kind of laser with earlier maturity and faster development. Because the utility model has the advantages of wide wavelength range, simple manufacture, low cost, easy mass production, small size, light weight, long service life, etc., the utility model is used for laser ranging, laser processing, laser medical treatment, laser display, laser communication, laser simulating weapon, etc., and forms a broad market. The utility model becomes the core technology of the optoelectronic science today.

Existing scanning schemes aiming at laser beams generally require a combination of a plurality of optical elements in order to realize light spot diversification to meet different application requirements, however, the structural form of the combination of the plurality of optical elements inevitably leads to the increase of the overall volume of the optical module, and the structural form is opposite to the miniaturization development requirement of the optical module.

### SUMMARY

The invention aims to provide an optical module and a laser system. The optical module and the laser system are small, compact in structure and capable of achieving diversification of forms of output light spots, so that different requirements can be met.

Embodiments of the present invention are implemented as follows:

In one aspect, the invention provides an optical module, comprising a first light emitting assembly, a second light emitting assembly, and a homogenizing lens group provided at light emitting sides of the first light emitting assembly and the second light emitting assembly; and

light beams emitted from the first light emitting assembly and the second light emitting assembly are respectively vertically incident at a light incident side of the homogenizing lens group, and the homogenizing lens group is configured to homogenize and emit the light beams incident by the first light emitting assembly and the second light emitting assembly to form a light spot. The optical module and the laser system are small and compact in structure, and can realize diversification of output light spots, so that different requirements can be met.

Alternatively, the homogenizing lens group comprises a first homogenizing lens and a second homogenizing lens arranged in a first direction, wherein the first homogenizing lens is configured to correspondingly receive the light beam emitted from the first light emitting assembly, and the second homogenizing lens is configured to correspondingly receive the light beam emitted from the second light emitting assembly; and the first homogenizing lens and the second homogenizing lens are independent optical elements or formed as an integral molding part.

Alternatively, the first light emitting assembly comprises a first substrate and a first light source packed on the first substrate; and the second light emitting assembly comprises a second substrate and a second light source packed on the second substrate, a light emitting surface of the first light source and a receiving surface are provided having an included angle therebetween, and a light emitting surface of the second light source and the receiving surface are provided having an included angle therebetween.

Alternatively, light emitting directions of the first light source and the second light source are both toward the receiving surface, a light emitting side of the first light source is parallel to a light incident side of the first homogenizing lens, and a light emitting side of the second light source is parallel to a light incident side of the second homogenizing lens; or

the light emitting direction of the second light source is not toward the receiving surface, the light emitting side of the first light source is parallel to the light incident side of the first homogenizing lens; and the second light emitting assembly further comprises a reflecting mirror, and the light beam emitted from the second light source is reflected by the reflecting mirror and then incident at the second homogenizing lens.

Alternatively, the first light emitting assembly comprises a first substrate, a first light source, and a first light transmitting potting body that packs the first light source on the first substrate, wherein the light beam emitted from the first light source is refracted by a surface of the first light transmitting potting body close to the first homogenizing lens and then incident at the first homogenizing lens; and the second light emitting assembly comprises a second substrate, a second light source, and a second light transmitting potting body that packs the second light source on the second substrate, and the light beam emitted from the second light source is refracted by a surface of the second light transmitting potting body close to the second homogenizing lens and then incident at the second homogenizing lens; and

the surface of the first light transmitting potting body close to the first homogenizing lens and a surface of the first light source close to the first homogenizing lens form a first preset included angle; and the surface of the second light transmitting potting body close to the second homogenizing lens and a surface of the second light source close to the second homogenizing lens form a second preset included angle.

Alternatively, light emitting directions of the first light source and the second light source are both toward a receiving surface; or

the light emitting direction of the second light source is not toward the receiving surface; and the second light emitting assembly further comprises a reflecting mirror, the light beam emitted from the second light source is refracted by a surface of the second light transmitting potting body close to the first homogenizing lens and then incident at the reflecting mirror, and is reflected by the reflecting mirror and then incident at the second homogenizing lens.

Alternatively, the first light emitting assembly comprises a first substrate and a first light source packed on the first substrate; and the second light emitting assembly comprises a second substrate and a second light source packed on the second substrate; and the first light emitting assembly further comprises a first wedge lens, the second light emitting assembly further comprises a second wedge lens, and the first wedge lens is provided on one side of the first homogenizing lens close to the first light source, and the second wedge lens is provided on one side of the second homogenizing lens close to the second light source.

Alternatively, light emitting directions of the first light source and the second light source are both toward the receiving surface; or

the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

Alternatively, the first light emitting assembly comprises a first substrate and a first light source packed on the first substrate, and a light emitting surface of the first light source and a receiving surface are provided having an included angle therebetween; and the second light emitting assembly comprises a second substrate, a second light source, and a second light transmitting potting body that packs the second light source on the second substrate, a surface of the second light transmitting potting body close to the second homogenizing lens and a surface of the second light source close to the second homogenizing lens form a second preset included angle, and the light beam emitted from the second light source is refracted by the surface of the second light transmitting potting body close to the second homogenizing lens and then incident at the second homogenizing lens.

Alternatively, light emitting directions of the first light source and the second light source are both toward the receiving surface, and a light emitting side of the first light source is parallel to a light incident side of the first homogenizing lens; or

the light emitting direction of the second light source is not toward the receiving surface, the second light emitting assembly further comprises a reflecting mirror, and the light beam emitted from the second light source is refracted by a surface of the second light transmitting potting body close to the first homogenizing lens and then incident at the reflecting mirror, and is reflected by the reflecting mirror and then incident at the second homogenizing lens.

Alternatively, the first light emitting assembly comprises a first substrate and a first light source packed on the first substrate, and a light emitting surface of the first light source and a receiving surface are provided having an included angle therebetween; and the second light emitting assembly comprises a second substrate, a second light source packed on the second substrate, and a second wedge lens provided on a side of the second homogenizing lens close to the second light source.

Alternatively, light emitting directions of the first light source and the second light source are both toward the receiving surface, and a light emitting side of the first light source is parallel to a light incident side of the first homogenizing lens; or

the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

Alternatively, the first light emitting assembly comprises a first substrate, a first light source, and a first light transmitting potting body that packs the first light source on the first substrate, a surface of the first light transmitting potting body close to the first homogenizing lens and a surface of the first light source close to the first homogenizing lens form a first preset included angle, and the light beam emitted from the first light source is refracted by the surface of the first light transmitting potting body close to the first homogenizing lens and then incident at the first homogenizing lens; and the second light emitting assembly comprises a second substrate, a second light source packed on the second substrate, and a second wedge lens provided on a side of the second homogenizing lens close to the second light source.

Alternatively, light emitting directions of the first light source and the second light source are both toward a receiving surface; or

the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

Alternatively, the optical module further comprises a first compressional mirror and a second compressional mirror, the first compressional mirror is provided between the first light emitting assembly and the homogenizing lens group, and the second compressional mirror is provided between the second light emitting assembly and the homogenizing lens group.

Alternatively, the optical module further comprises at least one third light emitting assembly, and light beams respectively emitted from the first light emitting assembly, the second light emitting assembly and the third light emitting assembly are homogenized and emitted by the homogenizing lens group to form a light spot.

On the other hand, the invention provides a laser system which comprises the optical module.

The beneficial effects of the present invention include:

The invention provides an optical module. When the optical module is in practical application, By adjusting the angle between the first light emitting assembly, the second light emitting assembly and the homogenizing lens group, so that the light beams emitted from the first light emitting assembly and the second light emitting assembly are homogenized by the homogenizing lens group, can emit mutually overlapped or separated light beams, further, separated or partially overlapped light spots can be formed on the receiving surface, For example, the flat-topped light spot in angular space, the moderate-intensity light spot in angular space, the moderate-intensity polarized light spot in angular space, or the separated light spots and the like can be formed on the receiving surface. The optical elements provided in the optical module provided by the present disclosure are compact in structure, small in number and low in cost, and can effectively reduce the overall volume of the optical module; and simultaneously, the optical module of the present disclosure can rearrange the light beams, change the characteristics of the light beams, and homogenize the light beams by adjusting the arrangement angles of the first light emitting assembly and the second light emitting assembly relative to the homogenizing lens group, which can achieve a specific light spot form on the receiving surface according to different application scenarios, and further realize the diversification of the forms of the output light spots.

### DESCRIPTION OF THE DRAWINGS

In order to more clearly illustrate the technical scheme of the embodiment of the invention, the accompanying drawings, which are intended to be used in the examples, will now be briefly described, It is to be understood that the following drawings illustrate only certain embodiments of the present invention and are therefore not to be construed as limiting the scope thereof, and that other related drawings may be obtained from these drawings without inventive effort by those of ordinary skill in the art

FIG. 1 is one of diagrammatic views of light spots emitted by an optical module according to an embodiment of the present invention;

FIG. 2 is a second schematic diagram of the emergent light spot of the optical module provided by the embodiment of the invention;

FIG. 3 is a schematic diagram of a light spot emitted by an optical module according to an embodiment of the present invention;

FIG. 4 is a schematic diagram of four light spots emitted by an optical module according to an embodiment of the present invention;

FIG. 5 is one of the structural diagrams corresponding to the first embodiment of the optical module provided by the embodiment of the invention;

FIG. 6 is a second schematic diagram of the structure corresponding to the first embodiment of the optical module provided by the embodiment of the invention;

FIG. 7 is a third schematic diagram of a structure corresponding to a first embodiment of the optical module provided by an embodiment of the present invention;

FIG. 8 is one of the structural diagrams corresponding to the second embodiment of the optical module provided by the embodiment of the invention;

FIG. 9 is a second schematic diagram corresponding to a second embodiment of the optical module provided by the embodiment of the invention;

FIG. 10 is one of the structural diagrams corresponding to a third embodiment of the optical module provided by an embodiment of the present invention;

FIG. 11 is a second schematic diagram of a structure corresponding to a third embodiment of the optical module provided by the embodiment of the invention;

FIG. 12 is a third schematic diagram of a structure corresponding to a third embodiment of the optical module provided by an embodiment of the present invention;

FIG. 13 is a fourth schematic diagram of a structure corresponding to a third embodiment of the optical module provided by an embodiment of the present invention;

FIG. 14 is a schematic diagram of a fourth embodiment of an optical module according to an embodiment of the present invention;

FIG. 15 is a second schematic diagram of a fourth embodiment of the optical module according to an embodiment of the present invention;

FIG. 16 is one of the structural diagrams corresponding to a fifth embodiment of the optical module provided by an embodiment of the present invention;

FIG. 17 is a second schematic diagram of a fifth embodiment of the optical module according to an embodiment of the present invention;

FIG. 18 is one of the structural diagrams corresponding to a sixth embodiment of the optical module provided by an embodiment of the present invention;

FIG. 19 is a second schematic diagram of a sixth embodiment of an optical module according to an embodiment of the present invention;

FIG. 20 is one of the schematic structural views of an optical module according to an embodiment of the present invention;

FIG. 21 is a second schematic diagram of an optical module according to an embodiment of the present invention;

FIG. 22 is a fourth schematic diagram of a structure corresponding to the first embodiment of the optical module provided by the embodiment of the invention.

Reference signs: 10—first light emitting assembly; 11—first substrate; 12—first light source; 13—first light transmitting potting body; 20—second light emitting assembly; 21—second substrate; 22—second light source; 23—second light transmitting potting body; 30—homogenizing lens group; 31—first homogenizing lens; 32—second homogenizing lens; θ1—first preset included angle; θ2—second preset included angle; A—first direction; 40—reflecting mirror; 51—first wedge lens; 52—second wedge lens; 61—first compressional mirror; 62—second compressional mirror; ω1—first deflection angle; ω2—second deflection angle; θ3—first divergence full angle; θ4—second divergence full angle.

### DETAILED DESCRIPTION

In order to make the purpose, technical scheme and advantages of the embodiment of the invention clearer, the following will be combined with the accompanying drawings of embodiments of the present invention, It will be apparent that the described embodiments are part of the embodiments of the present invention, and not all of the embodiments of the present invention, which are generally described and illustrated in the drawings herein, may be arranged and designed in a variety of different configurations

Accordingly, the following detailed description of embodiments of the invention provided in the drawings is not intended to limit the scope of the claimed invention, Rather, it is intended that only selected embodiments of the present invention be based on embodiments of the present invention, and that all other embodiments attained by those of ordinary skill in the art without inventive effort are within the scope of the present invention

It should be noted that like reference numerals and letters refer to like items in the accompanying drawings, so that once an item is defined in one of the drawings, it is not necessary to further define and interpret it in the following drawings

In the description of the invention, It should be noted that, The terms “center”, “upper”, “lower”, “left”, “right”, “vertical”, “horizontal”, “inner”, “outer”, and the like indicate azimuth or positional relationships based on the azimuth or positional relationships shown in the drawings, Or it is the orientation or position relation of the invented product when it is used, For purposes of convenience only of describing the present invention and simplifying the description, Rather than indicating or implying that the referenced device or element must have a particular orientation, be constructed and operated in a particular orientation, and therefore should not be construed as limiting the invention; in addition, the terms “first”, “second”, “third”, and the like are intended to distinguish between descriptions only and should not be construed as indicating or implying relative importance

In addition, the terms “horizontal”, “vertical” and the like do not mean that the component is required to be horizontal or overhanging, but rather may be slightly inclined, such as “horizontal” simply means that it is oriented more horizontally than “vertical”, rather than meaning that the structure must be completely horizontal, but rather may be slightly inclined

In the description of the present invention, it should also be noted that unless otherwise expressly specified and defined, the terms “provided”, “mounted”, “connected”, and “connected” are to be construed in a broad sense, for example, as either a fixed connection, or a detachable connection, or as an integral connection; Can be mechanical connection or electric connection; It may be direct connection or indirect connection via an intermediate medium, and it may be communication between the interiors of the two elements. It will be apparent to those of ordinary skill in the art that the specific meaning of the above-mentioned terms in the present invention will be understood in detail.

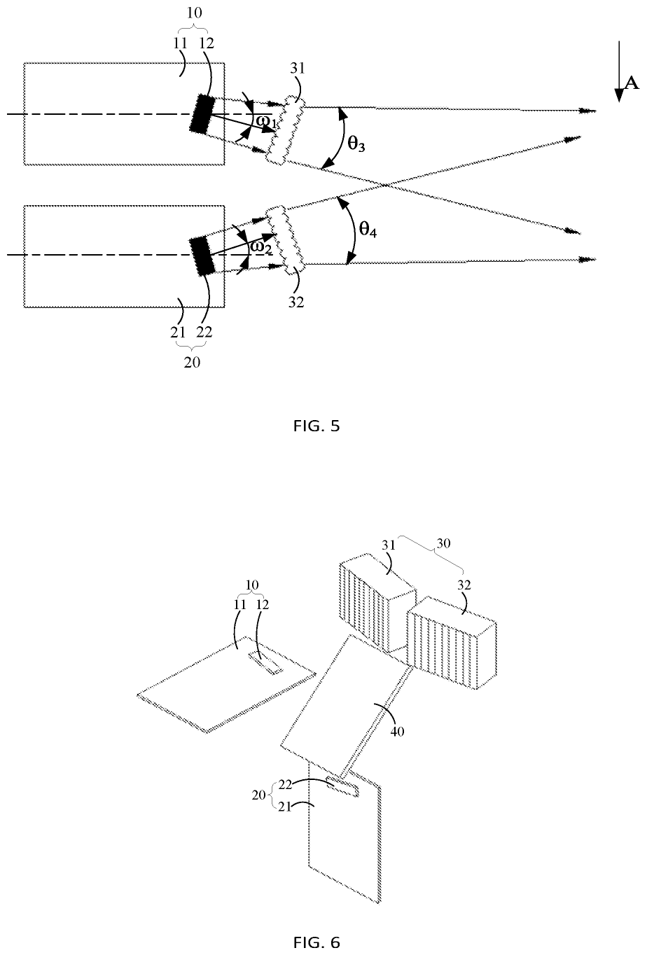

Referring to FIG. 5 to FIG. 20, the present embodiment provides an optical module. The optical module includes a first light emitting assembly 10, a second light emitting assembly 20, and a homogenizing lens group 30 provided at the light emitting sides of the first light emitting assembly 10 and the second light emitting assembly 20; the light beams emitted from the first light emitting assembly 10 and the second light emitting assembly 20 are respectively vertically incident at the light incident side of the homogenizing lens group 30, and the homogenizing lens group 30 homogenizes and emits the light beams incident by the first light emitting assembly 10 and the second light emitting assembly 20 to form a light spot. The optical module and the laser system are small in size and compact in structure, and can realize the diversification of the forms/shapes of output light spots, so as to adapt to different needs.

In the above, the first light emitting assembly 10 and the second light emitting assembly 20 are both configured to emit light beams. For example, the light beams emitted from the first light emitting assembly 10 and the second light emitting assembly 20 are laser beams.

The above-mentioned homogenizing lens group 30 is provided on the light emitting sides of the first light emitting assembly 10 and the second light emitting assembly 20, and is configured to homogenize and emit respectively the light beam emitted from the first light emitting assembly 10 and the light beam emitted from the second light emit assembly 20.

The light beams homogenized by the homogenizing lens group 30 may be emitted after beam combination to form superimposed light spots, or may also be emitted respectively to form separated light spots. In the above, if the light beams homogenized by the homogenizing lens group 30 need to be combined and emitted, a beam-combination mirror can be provided at one side of the homogenizing lens group 30 away from the first light emitting assembly 10 and the second light emitting assembly 20, or it can be realized by adjusting the light emitting angles of the first light emitting assembly 10 and/or the second light emitting assembly 20. It can be understood that the above-mentioned two implementations of beam combination are only examples of the present disclosure, and other corresponding implementations that can realize the beam combination are also applicable to the present disclosure.

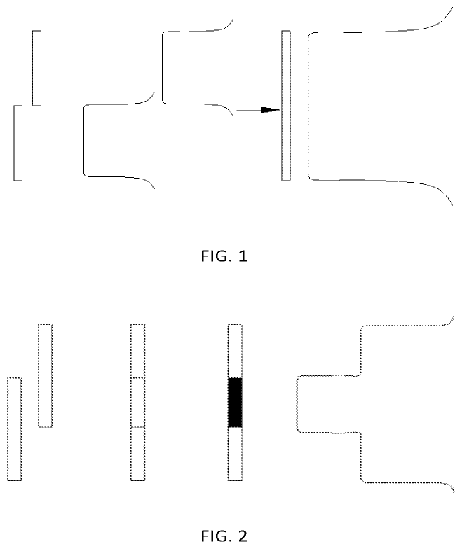

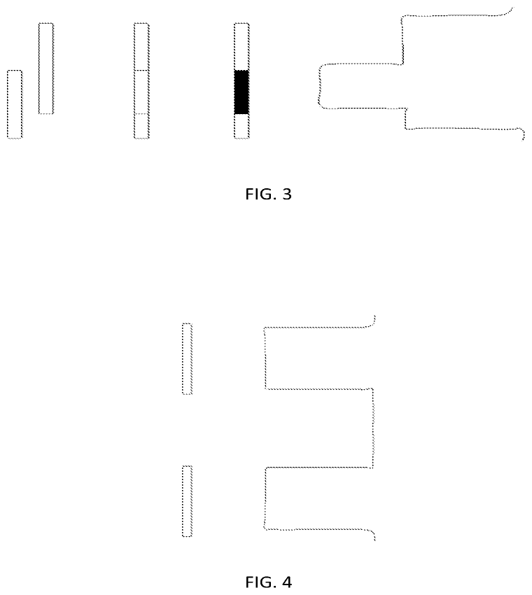

It is easy to understand that the optical module provided in the present disclosure can obtain separated or partially overlapped light spots on the receiving surface, by adjusting the arrangement mode between the first light emitting assembly 10, the second light emitting assembly 20 and the homogenizing lens group 30 (for example, mutual arrangement angles), and then flat-topped light spots in angular space, moderate-intensity light spots in angular space, moderate-intensity polarized light spots in angular space, or separated light spots and the like can be formed (as shown in FIG. 1 to FIG. 4). For specific application scenarios, those skilled in the art can choose to adjust the optical module according to actual needs, so as to obtain a specific light spot.

Also, in this embodiment, the first light emitting assembly 10 and the second light emitting assembly 20 may be provided side by side, as shown in FIG. 5, or may also be provided vertically, as shown in FIG. 6. It should be noted that when the first light emitting assembly 10 and the second light emitting assembly 20 are provided in parallel, and the light emitting directions of the first light emitting assembly 10 and the second light emitting assembly 20 are both toward the receiving surface; when the first light emitting assembly 10 and the second light emitting assembly 20 are provided vertically, the light emitting directions of the first light emitting assembly 10 and the second light emitting assembly 20 are vertical to each other, but the overall volume of the optical module can be compressed. It is easy to understand that the arrangement direction of the first light emitting assembly 10 and the second light emitting assembly 20 can be determined by those skilled in the art according to actual needs, which is not limited in the present disclosure.

In this embodiment, when the separated light spots need to be obtained, the sum of the absolute value of the deflection angle of the light beam emitted from the first light emitting assembly 10 relative to the first plane and the absolute value of the deflection angle of the light beam emitted from the second light emitting assembly 20 relative to the first plane is greater than half of the sum of the absolute value of the divergence full angle of the light beam of the first light emitting assembly 10 that is homogenized and emitted by the homogenizing lens group 30 and the absolute value of the divergence full angle of the light beam of the second light emitting assembly 20 that is homogenized and emitted by the homogenizing lens group 30.

When the flat-topped light spot needs to be obtained, the sum of the absolute value of the deflection angle of the light beam emitted from the first light emitting assembly 10 relative to the first plane and the absolute value of the deflection angle of the light beam emitted from the second light emitting assembly 20 relative to the first plane is equal to half of the sum of the absolute value of the divergence full angle of the light beam of the first light emitting assembly 10 that is homogenized and emitted by the homogenizing lens group 30 and the absolute value of the divergence full angle of the light beam of the second light emitting assembly 20 that is homogenized and emitted by the homogenizing lens group 30.

When the moderate-intensity light spot or the moderate-intensity polarized light spot needs to be obtained, the sum of the absolute value of the deflection angle of the light beam emitted from the first light emitting assembly 10 relative to the first plane and the absolute value of the deflection angle of the light beam emitted from the second light emitting assembly 20 relative to the first plane is smaller than half of the sum of the absolute value of the divergence full angle of the light beam of the first light emitting assembly 10 that is homogenized and emitted by the homogenizing lens group 30 and the absolute value of the divergence full angle of the light beam of the second light emitting assembly 20 that is homogenized and emitted by the homogenizing lens group 30.

In the above, it should be noted that the deflection angle of the light beam emitted from the first light emitting assembly 10 relative to the first plane is the angle between the light beam emitted from the first light emitting assembly 10 and the straight line perpendicular to the receiving surface, as shown in FIG. 5 and FIG. 8 and FIG. 10.

For ease of understanding, the following takes as an example that the first light emitting assembly 10 and the second light emitting assembly 20 are both subjected to a swing angle arrangement, a potting deflection arrangement, and a wedge lens deflection arrangement, to illustrate the arrangement methods of the first light emitting assembly 10 and the second light emitting assembly 20. In the above, the specific manners of the swing angle arrangement, the potting deflection arrangement and the wedge lens deflection arrangement will be described in detail below.

For ease of description, the deflection angle of the light beam emitted from the first light emitting assembly 10 relative to the first plane is now referred to as the first deflection angle ω1, and the deflection angle of the light beam emitted from the second light emitting assembly 20 relative to the first plane is referred to as the second deflection angle ω2, the divergence full angle of the light beam of the first light emitting assembly 10 that is homogenized and emitted by the homogenizing lens group 30 is referred to as the third divergence full angle θ3, and the divergence full angle of the light beam of the second light emitting assembly 20 that is homogenized and emitted by the homogenizing lens group 30 is referred to as the second divergence full angle θ4.

Referring to FIG. 5, FIG. 8 and FIG. 10, when the first light emitting assembly 10 and the second light emitting assembly 20 are provided in any one of the swing angle arrangement, the potting deflection arrangement and the wedge lens deflection arrangement, if it is desired to obtain separated light spots in the angular space on the receiving surface, the placement angles of the first light emitting assembly 10 and the second light emitting assembly 20 both need to satisfy the following formula:

$$\vert {ω}_{1} \vert + \vert {ω}_{2} \vert > \frac{1}{2} ( \vert {θ}_{3} \vert + \vert {θ}_{4} \vert )$$

if it is desired to obtain a beam-combined flat-topped light spot in the angular space on the receiving surface, the placement angles of the first light emitting assembly 10 and the second light emitting assembly 20 both need to satisfy the following formula:

$$\vert {ω}_{1} \vert + \vert {ω}_{2} \vert = \frac{1}{2} ( \vert {θ}_{3} \vert + \vert {θ}_{4} \vert )$$

if it is desired to obtain the moderate-intensity light spot or the moderate-intensity polarized light spot on the receiving surface, the placement angles of the first light emitting assembly 10 and the second light emitting assembly 20 both need to satisfy the following formula:

$$\vert {ω}_{1} \vert + \vert {ω}_{2} \vert < \frac{1}{2} ( \vert {θ}_{3} \vert + \vert {θ}_{4} \vert )$$

In the above, it should be noted that, referring to FIG. 5, when the first light emitting assembly 10 is provided in the swing angle arrangement, the first deflection angle ω1 is determined by the placement angle of the first light source 12 of the first light emitting assembly 10; referring to FIG. 8, when the first light emitting assembly 10 is provided in the potting deflection arrangement, the first deflection angle ω1 is determined by the placement angle of the first light transmitting potting body 13 of the first light emitting assembly 10; and referring to FIG. 10, when the first light emitting assembly 10 is provided in the wedge lens deflection arrangement, the first deflection angle ω1 is determined by the placement angle of the first wedge lens 51 of the first light emitting assembly 10.

Referring to FIG. 5, when the second light emitting assembly 20 is provided in the swing angle arrangement, the second deflection angle ω2 is determined by the placement angle of the second light source 22 of the second light emitting assembly 20; referring to FIG. 8, when the second light emitting assembly 20 is provided in the potting deflection arrangement, the second deflection angle ω2 is determined by the placement angle of the second light transmitting potting body 23 of the second light emitting assembly 20; and referring to FIG. 10, when the second light emitting assembly 20 is provided in the wedge lens deflection arrangement, the second deflection angle ω2 is determined by the placement angle of the second wedge lens 52 of the second light emitting assembly 20.

It should be noted that the above examples are only illustrated by taking as an example that both the first light emitting assembly 10 and the second light emitting assembly 20 are provided in the swing angle arrangement, in the potting deflection arrangement, and in the wedge lens deflection arrangement. When the placement methods of the first light emitting assembly 10 and the second light emitting assembly 20 are different (for example, one of the first light emitting assembly 10 and the second light emitting assembly 20 is provided in the swing angle arrangement, and the other is provided in the potting deflection arrangement; for another example, one of the first light emitting assembly 10 and the second light emitting assembly 20 is provided in the swing angle arrangement, and the other is provided in the wedge lens deflection arrangement; and for yet another example, one of the first light emitting assembly 10 and the second light emitting assembly 20 is provided in the potting deflection arrangement, and the other is provided in the wedge lens deflection arrangement), those skilled in the art can also simply derive it from the above description of the present disclosure, so the present disclosure may not explain each case one by one again.

To sum up, the present disclosure provides another optical module. The optical module includes a first light emitting assembly 10, a second light emitting assembly 20, and a homogenizing lens group 30 provided at the light emitting sides of the first light emitting assembly 10 and the second light emitting assembly 20; the light beams emitted from the first light emitting assembly 10 and the second light emitting assembly 20 are respectively vertically incident at the light incident side of the homogenizing lens group 30, and the homogenizing lens group 30 homogenizes and emits the light beams incident by the first light emitting assembly 10 and the second light emitting assembly 20 to form light spot(s). In practical application, the arrangement angles between the first light emitting assembly 10, the second light emitting assembly 20 and the homogenizing lens group 30 can be adjusted, so that after the light beams emitted from the first light emitting assembly 10 and the second light emitting assembly 20 are homogenized by the homogenizing lens group 30, light beams overlapping or separated from each other are emitted and then separated or partially overlapped light spots can be formed on the receiving surface, for example, the flat-topped light spot in angular space, the moderate-intensity light spot in angular space, the moderate-intensity polarized light spot in angular space, or the separated light spots and the like can be formed on the receiving surface. The optical elements provided in the optical module provided by the present disclosure are compact in structure, small in number and low in cost, and can effectively reduce the overall volume of the optical module; and simultaneously, the optical module of the present disclosure can rearrange the light beams, change the characteristics of the light beams, and homogenize the light beams by adjusting the arrangement angles of the first light emitting assembly 10 and the second light emitting assembly 20 relative to the homogenizing lens group 30, which can achieve a specific light spot form on the receiving surface according to different application scenarios, and further realize the diversification of the forms of the output light spots.

In this embodiment, as shown in FIG. 5, the above-mentioned homogenizing lens group 30 includes a first homogenizing lens 31 and a second homogenizing lens 32 arranged in the first direction A, wherein the first homogenizing lens 31 correspondingly receives the light beam emitted from the first light emitting assembly 10, and the second homogenizing lens 32 correspondingly receives the light beam emitted from the second light emitting assembly 20.

In the above, the first homogenizing lens 31 is configured to homogenize and emit the light beam emitted from the first light emitting assembly 10, and the second homogenizing lens 32 is configured to homogenize and emit the light beam emitted from the second light emitting assembly 20. In this way, one or more uniform light spots can be obtained on the receiving surface.

Further, the above-mentioned first homogenizing lens 31 and second homogenizing lens 32 may also be formed as an integral molded part. In this way, it is equivalent to that the homogenizing lens group 30 includes only one lens, for the convenience of introduction, the lens is hereinafter referred to as the third homogenizing lens. In this way, it can be considered that the third homogenizing lens has a first area and a second area that are provided at an interval or have borders connected with each other, the first homogenizing lens 31 is located in the first area, and the second homogenizing lens 32 is located in the second area.

It should be noted that the arrangement modes of the above-mentioned two types of homogenizing lens groups 30 including two independent lenses or including one lens with two areas are only examples, not a limitation on the homogenizing lens group 30, and those skilled in the art can select an appropriate arrangement mode of the homogenizing lens group 30 according to actual needs, and can also select other corresponding implementations that can realize homogenization and emission according to existing knowledge. The arrangement modes of the above-mentioned two types of homogenizing lens groups 30 are basically the same in principle. For the convenience of description, the following will take the example of the homogenizing lens group 30 including the first homogenizing lens 31 and the second homogenizing lens 32 for illustration.

The first light emitting assembly 10 and the second light emitting assembly 20 are respectively configured to emit light beams, and the specific forms of the first light emitting assembly 10 and the second light emitting assembly 20 will be exemplified below. It is easy to understand that the specific forms of the first light emitting assembly 10 and the second light emitting assembly 20 shown below are only examples, and should not be regarded as limitations on the first light emitting assembly 10 and the second light emitting assembly 20 provided in the present disclosure.

In the first embodiment, referring to FIG. 5 and FIG. 6 in combination, the first light emitting assembly 10 includes a first substrate 11 and a first light source 12 packed on the first substrate 11; the second light emitting assembly 20 includes a second substrate 21 and a second light source 22 packed on the second substrate 21; and a light emitting surface of the first light source 12 and a receiving surface are provided having an included angle therebetween, and a light emitting surface of the second light source 22 and the receiving surface are provided having an included angle therebetween.

In the above, the light beam emitted from the first light source 12 may be vertically incident at the first homogenizing lens 31, and the light beam emitted from the second light source 22 may be vertically incident at the second homogenizing lens 32.

It should be noted that the included angle between the light emitting surface of the first light source 12 and the receiving surface is between 0° and 90° (excluding 0° and 90°). Similarly, the included angle between the light emitting surface of the second light source 22 and the receiving surface is between 0° and 90° (excluding 0° and 90°). As mentioned above, according to the characteristics of the desired target light spot, for example, it is desired to obtain the separated light spots, the flat-topped light spot, the moderate-intensity light spot or the moderate-intensity polarized light spot or the like, the included angle between the light emitting surface of the first light source 12 and the receiving surface and/or the included angle between the light emitting surface of the second light source 22 and the receiving surface can be adjusted, so as to adjust the deflection angle of the light beam emitted from the first light emitting assembly 10 relative to the first plane and the deflection angle of the light beam emitted from the second light emitting assembly 20 relative to the first plane.

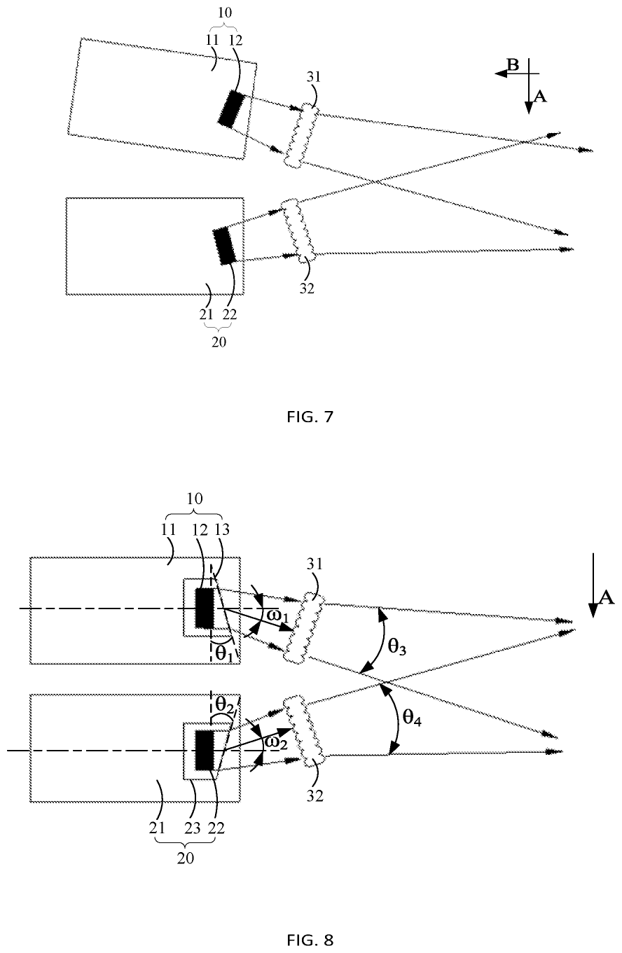

In the first case, referring to FIG. 5 and FIG. 7, the light emitting directions of the first light source 12 and the second light source 22 are both toward the receiving surface, the light emitting side of the first light source 12 is parallel to the light incident side of the first homogenizing lens 31, and the light emitting side of the second light source 22 is parallel to the light incident side of the second homogenizing lens 32. At this time, the light beam emitted from the first light source 12 can be vertically incident at the first homogenizing lens 31, and the light beam emitted from the second light source 22 can be vertically incident at the second homogenizing lens 32, so that the light beams can be combined with or separated from each other after homogenized and emitted to form the superimposed light spots or the separated light spots.

In the above, it should be noted that when the light emitting directions of the first light source 12 and the second light source 22 are both toward the receiving surface, the first light source 12 and the second light source 22 may be respectively located on the surfaces of the first substrate 11 and the second substrate 21 at a same side, may also be respectively located on surfaces of the first substrate 11 and the second substrate 21 at different sides. When the first light source 12 and the second light source 22 are respectively located on the surfaces of the first substrate 11 and the second substrate 21 at the different sides, the forms of the first light emitting assembly 10 and the second light emitting assembly 20 may be the same, that is, the package/encapsulation way of the first light source 12 on the first substrate 11 and the package way of the second light source 22 on the second substrate 21 are the same, which can reduce the number of BOMs of the optical module and reduce the assembly process of the product.

In the second case, referring to FIG. 6 and FIG. 22, optionally, the light emitting direction of the second light source 22 is not toward the receiving surface, and the light emitting side of the first light source 12 is parallel to the light incident side of the first homogenizing lens 31; and the second light emitting assembly also includes a reflecting mirror 40, and the light beam emitted from the second light source 22 is reflected by the reflecting mirror 40 and then incident at the second homogenizing lens 32.

In the above, the light emitting direction of the first light source 12 may or may not be toward the receiving surface. When the light emitting direction of the first light source 12 is toward the receiving surface, in this way, the light beam emitted from the first light source 12 can be directly incident at the receiving surface through the first homogenizing lens 31, and the direction of the light beam emitted from the second light source 22 and the direction of the light beam emitted from the first light source 12 are provided at an included angle (corresponding to FIG. 6, the included angle is 90°), and the light beam emitted from the second light source 22 cannot be incident at the receiving surface after passing through the second homogenizing lens 32, therefore, the reflecting mirror 40 needs to be correspondingly provided at the light emitting side of the second light source 22, so as to be incident at the second homogenizing lens 32 after being reflected by the reflecting mirror 40; and when the light emitting direction of the first light source 12 is also not toward the receiving surface, the reflecting mirror 40 is also correspondingly provided at the light emitting surface of the first light source 12, so that the light beam emitted from the first light source 12 is reflected by the reflecting mirror 40 and then incident at the second homogenizing lens 32.

It should be noted that those skilled in the art can select the arrangement modes of the first light source 12 and the second light source 22 according to needs, wherein when the light emitting directions of the first light source 12 and the second light source 22 are both toward the receiving surface (as shown in FIG. 5 and FIG. 7), the reflecting mirror 40 does not need to be provided, which can reduce the number of optical elements; and when the light emitting direction of any one of the first light source 12 and the second light source 22 is not toward the receiving surface, the reflecting mirror 40 needs to be correspondingly provided (that is, if only the light emitting direction of the second light source 22 is not toward the receiving surface, the reflecting mirror 40 only needs to be correspondingly provided at the light emitting side of the second light source 22; if only the light emitting direction of the first light source 12 is not toward the receiving surface, the reflecting mirror 40 only needs to be correspondingly provided at the light emitting side of the first light source 12; and if the light emitting directions of the first light source 12 and the second light source 22 are both not toward the receiving surface, the light emitting sides of the first light source 12 and the second light source 22 each need to be provided with the reflecting mirror 40), at this time, the overall volume of the optical module can be further reduced.

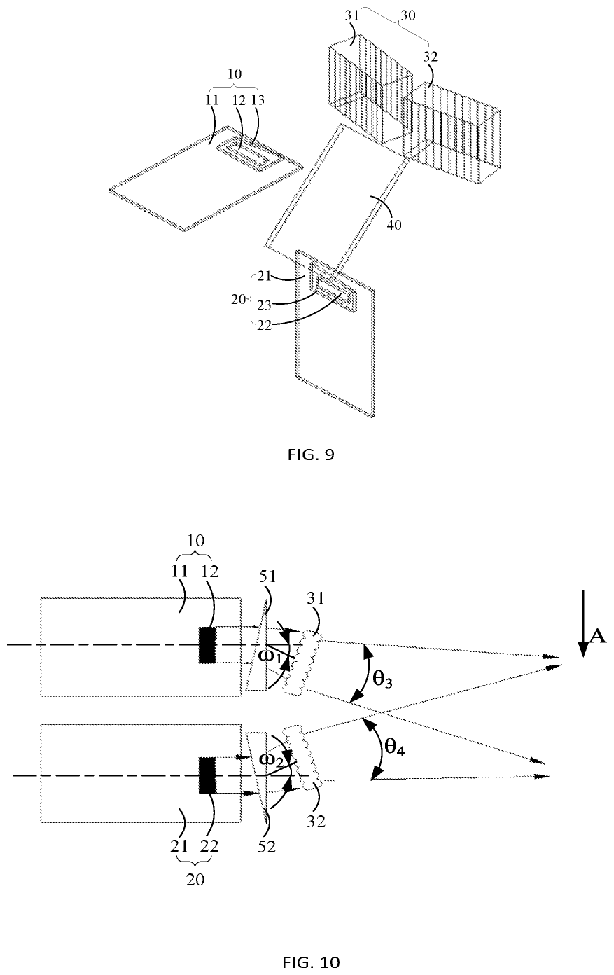

In this embodiment, when the light emitting direction of the first light source 12 is toward the receiving surface and the light emitting direction of the second light source 22 is not toward the receiving surface, the first light source 12 and the second light source 22 may be located on the same plane, or may be located on different planes. In the above, when the first light source 12 and the second light source 22 are located on different planes, as shown in FIG. 6, the first substrate 11 and the second substrate 21 can be provided at an included angle in a staggered way according to requirements, that is, there is a gap between the first substrate 11 and the orthographic projection of the second substrate 21 on the plane where the first substrate 11 is located; moreover, there is also a gap between the second substrate 21 and the orthographic projection of the first substrate 11 on the plane where the second substrate 21 is located. In the second embodiment, referring to FIG. 8 and FIG. 9 in combination, the first light emitting assembly 10 includes the first substrate 11, the first light source 12 and the first light transmitting potting body 13 that packs the first light source 12 on the first substrate 11, the light beam emitted from the first light source 12 is refracted by the surface of the first light transmitting potting body 13 close to the first homogenizing lens 31 and then incident at the first homogenizing lens 31; and the second light emitting assembly 20 comprises the second substrate 21, the second light source 22, and a second light transmitting potting body 23 that packs the second light source 22 on the second substrate 21, and the light beam emitted from the second light source 22 is refracted by the surface of the second light transmitting potting body 23 close to the second homogenizing lens 32 and then incident at the second homogenizing lens 32.

In the above, the first light transmitting potting body 13 is configured to perform potting of the first light source 12 on the first substrate 11, and the second light transmitting potting body 23 is configured to perform potting of the second light source 22 on the second substrate 21. For example, the materials of the first light transmitting potting body 13 and the second light transmitting potting body 23 can be selected from light transmitting optical materials, of which the specific types are not limited and can be chosen by those skilled in the art by themselves.

It should be understood that both the first light transmitting potting body 13 and the second light transmitting potting body 23 have a beam refraction effect, and can respectively refract the light beams emitted from the first light source 12 and the second light source 22. Those skilled in the art can correspondingly select an appropriate optical material as the material of the first light transmitting potting body 13 according to the beam angle incident at the first homogenizing lens 31, and the same is true for the second light transmitting potting body 23.

Optionally, the surface of the first light transmitting potting body 13 close to the first homogenizing lens 31 and the surface of the first light source 12 close to the first homogenizing lens 31 form the first preset included angle θ1; and the surface of the second light transmitting potting body 23 close to the second homogenizing lens 32 and the surface of the second light source 22 close to the second homogenizing lens 32 form the second preset included angle θ2. In this way, the light beam emitted from the first light source 12 may be refracted after passing through the first light transmitting potting body 13, similarly, the light beam emitted from the second light source 22 may also be refracted after passing through the second light transmitting potting body 23, so as to change the deflection angle of the beam, thereby achieving output of a specific light spot.

In this embodiment, the deflection angles of the light beams can be changed by changing the first preset included angle θ1 and the second preset included angle θ2, thereby realizing the output of light spots of different forms. It is also possible to change the corresponding refractive indexes by changing the materials of the first light transmitting potting body 13 and the second light transmitting potting body 23, and the change of the refractive indexes can realize the change of the deflection angles of the light beams, thereby realizing the output of light spots of different forms.

In this embodiment, according to the characteristics of the desired target light spot(s) (for example, it is desired to obtain the separated light spots, the flat-topped light spot, the moderate-intensity light spot or the moderate-intensity polarized light spot or the like), the included angle between the light emitting surface of the first light transmitting potting body 13 and the receiving surface and/or the included angle between the light emitting surface of the second light transmitting potting body 23 and the receiving surface can be adjusted, so as to adjust the deflection angle of the light beam emitted from the first light emitting assembly 10 relative to the first plane and the deflection angle of the light beam emitted from the second light emitting assembly 20 relative to the first plane.

In the first case, in this embodiment, the light emitting directions of the first light source 12 and the second light source 22 are both toward the receiving surface. At this time, referring to FIG. 8, the first substrate 11 and the second substrate 21 are located on the same plane, and the first light source 12 and the second light source 22 are located on the same side of the plane.

In the above, it should be noted that when the light emitting directions of the first light source 12 and the second light source 22 are both toward the receiving surface, the first light source 12 and the second light source 22 may also be located on surfaces of the first substrate 11 and the second substrate 21 at different sides respectively, at this time, the forms of the first light emitting assembly 10 and the second light emitting assembly 20 may be the same, that is, the package way of the first light source 12 on the first substrate 11 and the package way of the second light source 22 on the second substrate 21 are the same, which can reduce the number of BOMs of the optical module and reduce the assembly process of the product.

In the second case, in this embodiment, the light emitting direction of the second light source 22 is not toward the receiving surface. At this time, referring to FIG. 9, the second light emitting assembly further includes the reflecting mirror 40, and the light beam emitted from the second light source 22 is refracted by the surface of the second light transmitting potting body 23 close to the first homogenizing lens 31 and then incident at the reflecting mirror 40, and is reflected by the reflecting mirror 40 and then incident at the second homogenizing lens 32.

In the above, the light emitting direction of the first light source 12 may or may not be toward the receiving surface. When the light emitting direction of the first light source 12 is toward the receiving surface, the light beam emitted from the first light source 12 can be directly incident at the receiving surface through the first homogenizing lens 31, and the light beam emitted from the second light source 22 cannot be incident at the receiving surface after passing through the second homogenizing lens 32, therefore, the reflecting mirror 40 needs to be correspondingly provided at the light emitting side of the second light source 22, so that the light is incident at the second homogenizing lens 32 after being reflected by the reflecting mirror 40; and when the light emitting direction of the first light source 12 is also not toward the receiving surface, the reflecting mirror 40 is also correspondingly provided at the light emitting surface of the first light source 12, so that the light beam emitted from the first light source 12 is reflected by the reflecting mirror 40 and then incident at the second homogenizing lens 32.

Similar to the first embodiment, those skilled in the art can select the arrangement modes of the first light source 12 and the second light source 22 according to needs, wherein when the light emitting directions of the first light source 12 and the second light source 22 are both toward the receiving surface (as shown in FIG. 8), the reflecting mirror 40 does not need to be provided, which can reduce the number of optical elements; and when the light emitting direction of any one of the first light source 12 and the second light source 22 is not toward the receiving surface, the reflecting mirror 40 needs to be correspondingly provided, at this time, the overall volume of the optical module can be further reduced.

Similar to the first embodiment, in this embodiment, when the light emitting direction of the first light source 12 is toward the receiving surface and the light emitting direction of the second light source 22 is not toward the receiving surface, the first light source 12 and the second light source 22 may be located on the same plane, or may be located on different planes. When the first light source 12 and the second light source 22 are located on different planes, as shown in FIG. 9, the first substrate 11 and the second substrate 21 can be provided at an included angle in a staggered way according to requirements, that is, there is a gap between the first substrate 11 and the orthographic projection of the second substrate 21 on the plane where the first substrate 11 is located; moreover, there is also a gap between the second substrate 21 and the orthographic projection of the first substrate 11 on the plane where the second substrate 21 is located. In the third embodiment, referring to FIG. 10 to FIG. 13 in combination, the first light emitting assembly 10 comprises a first substrate 11 and a first light source 12 packed on the first substrate 11; the second light emitting assembly 20 comprises a second substrate 21 and a second light source 22 packed on the second substrate 21; and the first light emitting assembly 10 further comprises a first wedge lens 51, the second light emitting assembly 20 further comprises a second wedge lens 52, and the first wedge lens 51 is provided on one side of the first homogenizing lens 31 close to the first light source 12, and the second wedge lens 52 is provided on one side of the second homogenizing lens 32 close to the second light source 22.

In this way, in the present disclosure, the light beam emitted from the first light source 12 can be refracted and emitted through the first wedge lens 51, so as to be incident at the first homogenizing lens 31; and the light beam emitted from the second light source 22 can be refracted and emitted through the second wedge lens 52, so as to be incident at the second homogenizing lens 32, thereby realizing the output of the light spot with a specific form.

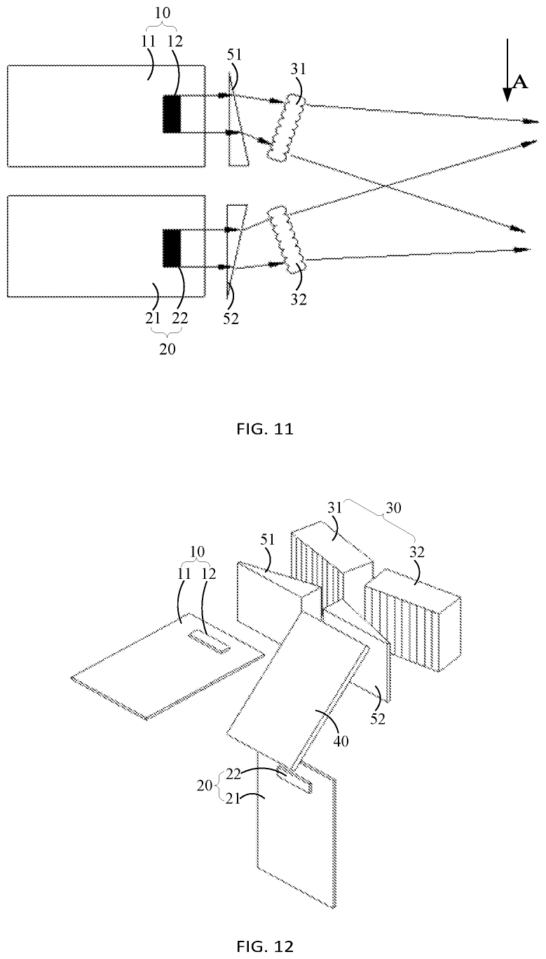

It should be noted that, in this embodiment, the sharp corner of the first wedge lens 51 and the sharp corner of the second wedge lens 52 are provided opposite to each other, as shown in FIG. 10 and FIG. 11. However, the present disclosure does not limit the orientation of the inclined surfaces of the first wedge lens 51 and the second wedge lens 52, as shown in FIG. 10, the inclined surfaces of the first wedge lens 51 and the second wedge lens 52 both face away from the homogenizing lens group 30; and also as shown in FIG. 11, the inclined surfaces of the first wedge lens 51 and the second wedge lens 52 are both toward the homogenizing lens group 30, which is not limited in this present disclosure, and those skilled in the art can select a suitable manner according to needs.

In this embodiment, according to the characteristics of the desired target light spot (for example, it is desired to obtain the separated light spots, the flat-topped light spot, the moderate-intensity light spot or the moderate-intensity polarized light spot or the like), the included angle between the light incident surface and the light emitting surface of the first wedge lens 51 and/or the included angle between the light incident surface and the light emitting surface of the second wedge lens 52 can be adjusted, so as to adjust the deflection angle of the light beam emitted from the first light emitting assembly 10 relative to the first plane and the deflection angle of the light beam emitted from the second light emitting assembly 20 relative to the first plane.

In the first case, in this embodiment, the light emitting directions of the first light source 12 and the second light source 22 are both toward the receiving surface.

In the above, when the light emitting directions of the first light source 12 and the second light source 22 are both toward the receiving surface, the first light source 12 and the second light source 22 may be respectively located on the surfaces of the first substrate 11 and the second substrate 21 at the same side (as shown in FIG. 10), or may also be respectively located on the surfaces of the first substrate 11 and the second substrate 21 at different sides. When the first light source 12 and the second light source 22 are respectively located on the surfaces of the first substrate 11 and the second substrate 21 at the different sides, the forms of the first light emitting assembly 10 and the second light emitting assembly 20 may be the same, that is, the package way of the first light source 12 on the first substrate 11 and the package way of the second light source 22 on the second substrate 21 are the same, which can reduce the number of BOMs of the optical module and reduce the assembly process of the product.

In the second case, in this embodiment, the light emitting direction of the second light source 22 is not toward the receiving surface; the second light emitting assembly further includes the reflecting mirror 40, and the light beam emitted from the second light source 22 is reflected by the reflecting mirror 40 and then incident at the second wedge lens 52, and is refracted by the second wedge lens 52 and then incident at the second homogenizing lens 32.

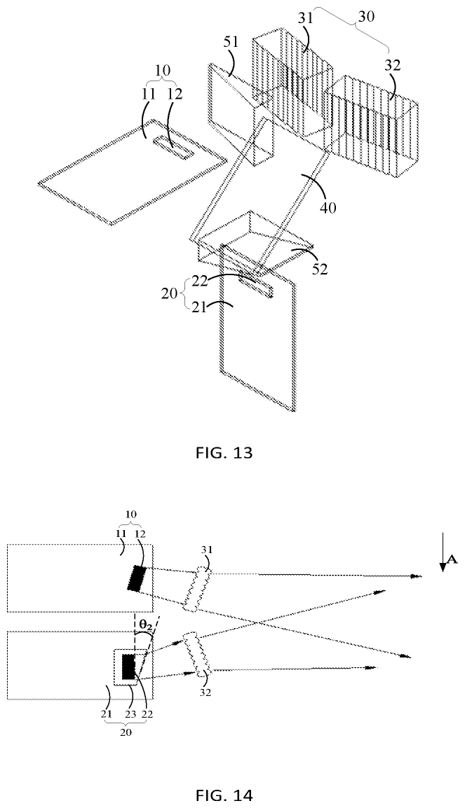

Here, it should be noted that the light emitting direction of the first light source 12 may or may not be toward the receiving surface. When the light emitting direction of the first light source 12 is toward the receiving surface and the light emitting direction of the second light source 22 is not toward the receiving surface, the second wedge lens 52 may be provided between the reflecting mirror 40 and the second light source 22 (as shown in FIG. 12), or may be provided between the reflecting mirror 40 and the second homogenizing lens 32 (as shown in FIG. 13). Those skilled in the art can select the arrangement position of the second wedge lens 52 according to needs. When the light emitting direction of the first light source 12 is not toward the receiving surface, the reflecting mirror 40 should also be provided at the light emitting side of the first light source 12, at this time, similarly, the first wedge lens 51 may be provided between the reflecting mirror 40 and the first light source 12, or may be provided between the reflecting mirror 40 and the first homogenizing lens 31.

Those skilled in the art can select the arrangement modes of the first light source 12 and the second light source 22 according to needs, wherein when the light emitting directions of the first light source 12 and the second light source 22 are both toward the receiving surface (as shown in FIG. 10), there is no need to provide the reflecting mirror 40, thus the number of optical elements can be reduced; and when the light emitting direction of any one of the first light source 12 and the second light source 22 is not toward the receiving surface, the reflecting mirror 40 needs to be provided accordingly, and at this time the overall volume of the optical module can be further reduced.

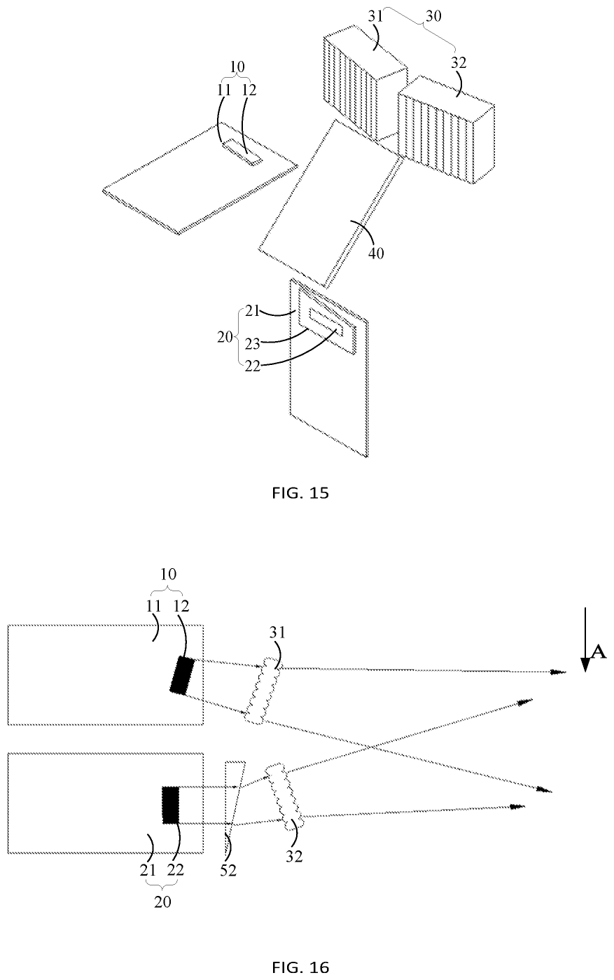

Besides, similar to the first embodiment and the second embodiment, when the light emitting direction of the first light source 12 is toward the receiving surface and the light emitting direction of the second light source 22 is not toward the receiving surface, the first light source 12 and the second light source 22 may be located on the same plane, or may be located on different planes. In the above, when the first light source 12 and the second light source 22 are located on different planes, as shown in FIG. 12 and FIG. 13, the first substrate 11 and the second substrate 21 can be provided at an included angle in a staggered way according to needs, that is, there is a gap between the first substrate 11 and the orthographic projection of the second substrate 21 on the plane where the first substrate 11 is located; moreover, there is also a gap between the second substrate 21 and the orthographic projection of the first substrate 11 on the plane where the second substrate 21 is located. In the fourth embodiment, referring to FIG. 14 and FIG. 15 in combination, the first light emitting assembly 10 comprises the first substrate 11 and the first light source 12 packed on the first substrate 11, wherein the light emitting surface of the first light source 12 and the receiving surface are provided having an included angle therebetween; and the second light emitting assembly 20 comprises the second substrate 21, the second light source 22, and the second light transmitting potting body 23 that packs the second light source 22 on the second substrate 21, wherein the surface of the second light transmitting potting body 23 close to the second homogenizing lens 32 and the surface of the second light source 22 close to the second homogenizing lens 32 form a second preset included angle 02, and the light beam emitted from the second light source 22 is refracted by the surface of the second light transmitting potting body 23 close to the second homogenizing lens 32 and then incident at the second homogenizing lens 32.

That is, in the present embodiment, the first light emitting assembly 10 uses the arrangement mode of the first light emitting assembly 10 in the first embodiment, and the second light emitting assembly 20 uses the arrangement mode of the second light emitting assembly 20 in the second embodiment. In this way, the package angle of the first light source 12 of the first light emitting assembly 10 on the first substrate 11 and/or the material or the arrangement angle of the emitting surface of the second light transmitting potting body 23 of the second light emitting assembly 20 can be changed, so that the light beams emitted from the first light emitting assembly 10 and the second light emitting assembly 20 can be vertically incident at the light incident side of the homogenizing lens group 30 respectively, so as to obtain a specific light spot form on the receiving surface according to different application scenarios, and further realize the purpose of diversification of forms of the output light spots.

Because the first light emitting assembly 10 uses the arrangement mode of the first light emitting assembly 10 in the first embodiment, the arrangement mode of the second light emitting assembly 20 is also the same as that of the second light emitting assembly 20 in the second embodiment, i.e. having same specific structure and effect. For the same part, reference can be made to the detailed description of the second light emitting assembly 20 in the second embodiment.

In the embodiment, according to the characteristics of the desired target light spot, for example, it is desired to obtain the separated light spots, the flat-topped light spot, the moderate-intensity light spot or the moderate-intensity polarized light spot or the like, the included angle between the light emitting surface of the first light source 12 and the receiving surface and/or the included angle between the light emitting surface of the second light transmitting potting body 23 and the receiving surface can be adjusted, so as to adjust the deflection angle of the light beam emitted from the first light emitting assembly 10 relative to the first plane and the deflection angle of the light beam emitted from the second light emitting assembly 20 relative to the first plane.

In the first case, referring to FIG. 14, the light emitting directions of the first light source 12 and the second light source 22 are both toward the receiving surface, and the light emitting side of the first light source 12 is parallel to the light incident side of the first homogenizing lens 31.

At this time, same to the first embodiment, the first light source 12 and the second light source 22 may be located on the surfaces of the first substrate 11 and the second substrate 21 at the same side respectively, or may be located on the surfaces of the first substrate 11 and the second substrate 21 at different sides respectively. When the first light source 12 and the second light source 22 are respectively located on the surfaces of the first substrate 11 and the second substrate 21 at the different sides, the forms of the first light emitting assembly 10 and the second light emitting assembly 20 may be the same (that is, the package way of the first light source 12 on the first substrate 11 and the package way of the second light source 22 on the second substrate 21 are the same), which can reduce the number of BOMs of the optical module and reduce the assembly process of the product.

In the second case, referring to FIG. 15, the light emitting direction of the second light source 22 is not toward the receiving surface, the second light emitting assembly 20 further includes a reflecting mirror 40, the light beam emitted from the second light source 22 is refracted by the surface of the second light transmitting potting body 23 close to the first homogenizing lens 31 and then incident at the reflecting mirror 40, and is reflected by the reflecting mirror 40 and then incident at the second homogenizing lens 32.

At this time, same to the second embodiment, the light emitting direction of the first light source 12 may or may not be toward the receiving surface. When the light emitting direction of the first light source 12 also is not toward the receiving surface, at this time, the reflecting mirror 40 is also correspondingly provided on the light emitting surface of the first light source 12, so that the light beam emitted from the first light source 12 is reflected by the reflecting mirror 40 and then incident at the second homogenizing lens 32; conversely, there is no need to provide the reflecting mirror 40 on the light emitting side of the first light source 12.

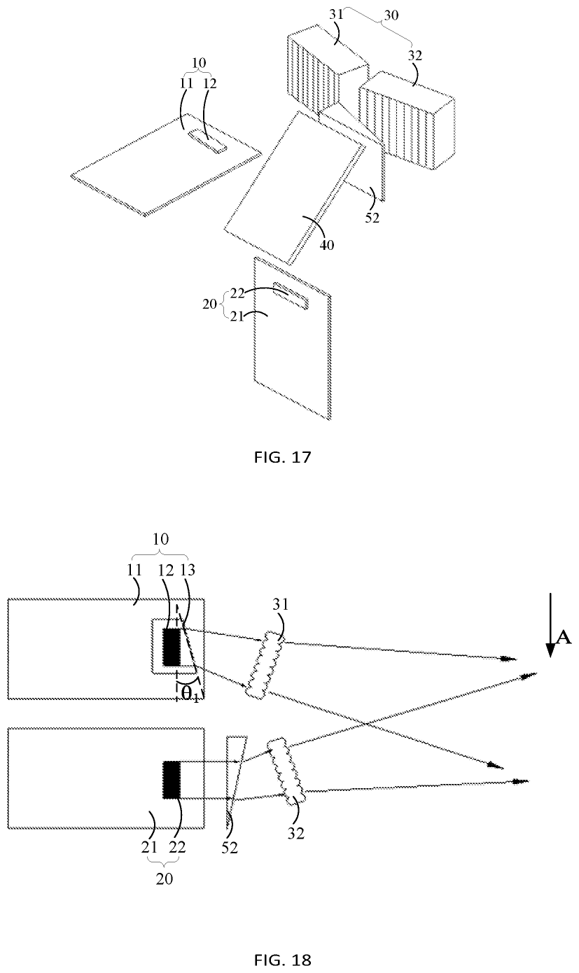

Same to the second embodiment, in this embodiment, when the light emitting direction of the first light source 12 is toward the receiving surface and the light emitting direction of the second light source 22 is not toward the receiving surface, the first light source 12 and the second light source 22 can be located on the same plane or on different planes. When the first light source 12 and the second light source 22 are located on different planes, as shown in FIG. 15, the first substrate 11 and the second substrate 21 may be provided at an included angle in a staggered way according to needs. In the above, the definition of being provided at an included angle in a staggered way is the same as that of the second embodiment, and will not be repeated in the present disclosure. In the fifth embodiment, referring to FIG. 16 and FIG. 17 in combination, the first light emitting assembly 10 includes the first substrate 11 and the first light source 12 packed on the first substrate 11; and the second light emitting assembly 20 includes the second substrate 21, the second light source 22 packed on the second substrate, and the second wedge lens 52 provided on one side of the second homogenizing lens 32 close to the second light source 22.

That is, in the present embodiment, the first light emitting assembly 10 uses the arrangement mode of the first light emitting assembly 10 in the first embodiment, and the second light emitting assembly 20 uses the arrangement mode of the second light emitting assembly 20 in the third embodiment. In this way, the package angle of the first light source 12 of the first light emitting assembly 10 on the first substrate 11 and/or arrangement angle between the light incident surface and the light emitting surface of the second wedge lens 52 of the second light emitting assembly 20 can be changed, so that the light beams emitted from the first light emitting assembly 10 and the second light emitting assembly 20 can be vertically incident at the light incident side of the homogenizing lens group 30 respectively, so as to obtain a specific light spot form on the receiving surface according to different application scenarios, and further realize the purpose of diversification of forms of the output light spots.

Because the first light emitting assembly 10 uses the arrangement mode of the first light emitting assembly 10 in the first embodiment, the arrangement mode of the second light emitting assembly 20 is also the same as that of the second light emitting assembly 20 in the third embodiment, i.e., having same specific structure and effect. For the same part, reference can be made to the detailed description of the second light emitting assembly 20 in the third embodiment.

In this embodiment, according to the characteristics of the desired target light spot, for example, it is desired to obtain the separated light spots, the flat-topped light spot, the moderate-intensity light spot or the moderate-intensity polarized light spot or the like, the included angle between the light emitting surface of the first light source 12 and the receiving surface and/or the included angle between the light incident surface and the light emitting surface of the second wedge lens 52 can be adjusted, so as to adjust the deflection angle of the light beam emitted from the first light emitting assembly 10 relative to the first plane and the deflection angle of the light beam emitted from the second light emitting assembly 20 relative to the first plane.

In the first case, referring to FIG. 16, the light emitting directions of the first light source 12 and the second light source 22 are both toward the receiving surface, and the light emitting side of the first light source 12 is parallel to the light incident side of the first homogenizing lens 31.

In the above, same to the first embodiment, when the light emitting directions of the first light source 12 and the second light source 22 are both toward the receiving surface, the first light source 12 and the second light source 22 may be located on the surfaces of the first substrate 11 and the second substrate 21 at the same side respectively, or may be located on the surfaces of the first substrate 11 and the second substrate 21 at different sides respectively. When the first light source 12 and the second light source 22 are respectively located on the surfaces of the first substrate 11 and the second substrate 21 at different sides, the forms of the first light emitting assembly 10 and the second light emitting assembly 20 may be the same, that is, the package way of the first light source 12 on the first substrate 11 and the package way of the second light source 22 on the second substrate 21 are the same.

In the second case, referring to FIG. 17, the light emitting direction of the second light source 22 is not toward the receiving surface; and the second light emitting assembly 20 further includes the reflecting mirror 40, and the light beam emitted from the second light source 22 is reflected by the reflecting mirror 40 and then incident at the second wedge lens 52, and is refracted by the second wedge lens 52 and then incident at the second homogenizing lens 32.

Same to the third embodiment, the light emitting direction of the first light source 12 may or may not be toward the receiving surface. When the light emitting direction of the first light source 12 is toward the receiving surface and the light emitting direction of the second light source 22 is not toward the receiving surface, the second wedge lens 52 may be provided between the reflecting mirror 40 and the second light source 22 (as shown in FIG. 17), or may be provided between the reflecting mirror 40 and the second homogenizing lens 32. When the light emitting direction of the first light source 12 is not toward the receiving surface, the reflecting mirror 40 should also be provided at the light emitting side of the first light source 12, at this time, similarly, the first wedge lens 51 may be provided between the reflecting mirror 40 and the first light source 12, or may be provided between the reflecting mirror 40 and the first homogenizing lens 31.

Those skilled in the art can select the arrangement modes of the first light source 12 and the second light source 22 according to the needs, wherein when the light emitting directions of the first light source 12 and the second light source 22 are both toward the receiving surface (as shown in FIG. 16), there is no need to provide the reflecting mirror 40; conversely, the reflecting mirror 40 needs to be provided accordingly.

Also, same to the third embodiment, when the light emitting direction of the first light source 12 is toward the receiving surface and the light emitting direction of the second light source 22 is not toward the receiving surface, the first light source 12 and the second light source 22 may be located on the same plane, or may be located on different planes. When the first light source 12 and the second light source 22 are located on different planes, as shown in FIG. 17, the first substrate 11 and the second substrate 21 can be provided at an included angle in a staggered way according to needs.

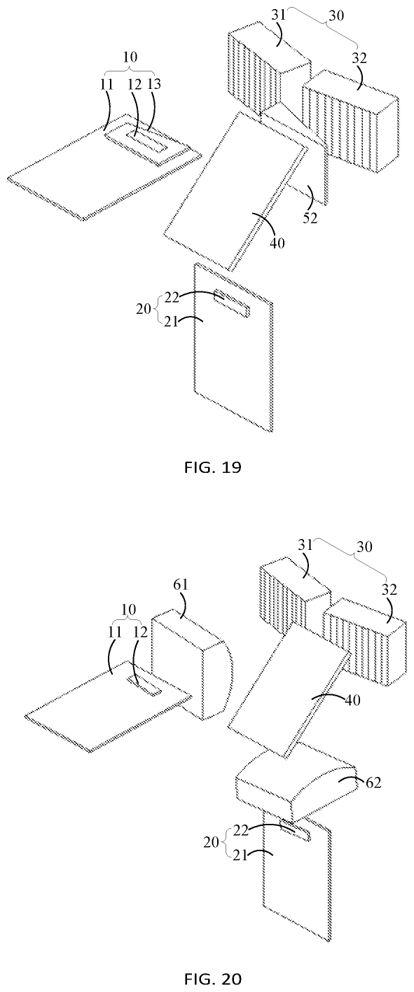

In the sixth embodiment, referring to FIG. 18 and FIG. 19 in combination, the first light emitting assembly 10 includes the first substrate, the first light source 12 and the first light transmitting potting body 13 that packs the first light source 12 on the first substrate 11, the surface of the first light transmitting potting body 13 close to the first homogenizing lens 31 and the surface of the first light source 12 close to the first homogenizing lens 31 form the first preset included angle θ1; the light beam emitted from the first light source is refracted by the surface of the first light transmitting potting body 13 close to the first homogenizing lens 31 and then incident at the first homogenizing lens 31; and the second light emitting assembly 20 comprises the second substrate 21, the second light source 22 packed on the second substrate 21, and the second wedge lens 52 provided on the side of the second homogenizing lens 32 close to the second light source 22.

That is, in the present embodiment, the first light emitting assembly 10 uses the arrangement mode of the first light emitting assembly 10 in the second embodiment, and the second light emitting assembly 20 uses the arrangement mode of the second light emitting assembly 20 in the third embodiment. In this way, the material or the arrangement angle of the emitting surface of the first light transmitting potting body 13 of the first light emitting assembly 10, and/or the arrangement angle between the light incident surface and the light emitting surface of second wedge lens 52 of the second light emitting assembly 20 can be changed, so that the light beams emitted from the first light emitting assembly 10 and the second light emitting assembly 20 can be vertically incident at the light incident side of the homogenizing lens group 30 respectively, so as to obtain the specific light spot form on the receiving surface according to different application scenarios, and further realize the purpose of diversification of forms of the output light spot.

Because the first light emitting assembly 10 uses the arrangement mode of the first light emitting assembly 10 in the second embodiment, the arrangement method of the second light emitting assembly 20 is also the same as that of the second light emitting assembly 20 in the third embodiment, i.e., having same specific structure and effect. For the same part, reference can be made to the detailed description of the second light emitting assembly 20 in the third embodiment.

In this embodiment, according to the characteristics of the desired target light spot, for example, it is desired to obtain the separated light spots, the flat-topped light spot, the moderate-intensity light spot or the moderate-intensity polarized light spot or the like, the included angle between the light emitting surface of the first light transmitting potting body 13 and the receiving surface and/or the included angle between the light incident surface and the light emitting surface of the second wedge lens 52 can be adjusted, so as to adjust the deflection angle of the light beam emitted from the first light emitting assembly 10 relative to the first plane and the deflection angle of the light beam emitted from the second light emitting assembly 20 relative to the first plane.

In the first case, referring to FIG. 18, the light emitting directions of the first light source 12 and the second light source 22 are both toward the receiving surface.

Same to the second embodiment, when the light emitting directions of the first light source 12 and the second light source 22 are both toward the receiving surface, the first light source 12 and the second light source 22 may also be located on the surfaces of the first substrate 11 and the second substrate 21 at different sides respectively, at this time, the forms of the first light emitting assembly 10 and the second light emitting assembly 20 may be the same, that is, the package way of the first light source 12 on the first substrate 11 and the package way of the second light source 22 on the second substrate 21 are the same, which can reduce the number of BOMs of the optical module and reduce the assembly process of the product.

In the second case, referring to FIG. 19, the light emitting direction of the second light source 22 is not toward the receiving surface; and the second light emitting assembly 20 further includes the reflecting mirror 40, and the light beam emitted from the second light source 22 is reflected by the reflecting mirror 40 and then incident at the second wedge lens, and then is refracted by the second wedge lens and then incident at the second homogenizing lens.

Same to the third embodiment, the light emitting direction of the first light source 12 may or may not be toward the receiving surface. When the light emitting direction of the first light source 12 is toward the receiving surface and the light emitting direction of the second light source 22 is not toward the receiving surface, the second wedge lens 52 may be provided between the reflecting mirror 40 and the second light source 22 (as shown in FIG. 19), or may be provided between the reflecting mirror 40 and the second homogenizing lens 32. When the light emitting direction of the first light source 12 is not toward the receiving surface, the reflecting mirror 40 should also be provided at the light emitting side of the first light source 12.

Those skilled in the art can select the arrangement modes of the first light source 12 and the second light source 22 according to the needs, wherein when the light emitting directions of the first light source 12 and the second light source 22 are both toward the receiving surface (as shown in FIG. 10), there is no need to provide the reflecting mirror 40; conversely, the reflecting mirror 40 needs to be provided accordingly.

Besides, same to the third embodiment, when the light emitting direction of the first light source 12 is toward the receiving surface and the light emitting direction of the second light source 22 is not toward the receiving surface, the first light source 12 and the second light source 22 can be located on the same plane or on different planes. When the first light source 12 and the second light source 22 are located on different planes, as shown in FIG. 19, the first substrate 11 and the second substrate 21 may be provided at an included angle in a staggered way according to needs. In the above, the manner of being provided at an included angle in a staggered way is consistent with the principle of the first substrate 11 and the second substrate 21 being provided at an included angle in a staggered way as described above, and will not be repeated in the present disclosure.

It should be noted that, in this embodiment as well as in the six embodiments mentioned above, the first substrate 11, the second substrate 21, the first homogenizing lens 31 and the second homogenizing lens 32 are correspondingly connected with a motor respectively, so that the corresponding optical element is driven by the motor to adjust the angle. In this way, when a specific light spot needs to be output, the user only needs to start the motor according to the needs, so as to adjust correspondingly the arrangement angles of one or more of the first substrate 11, the second substrate 21, the first homogenizing lens 31 and the second homogenizing lens 32, so that the arrangement angles of the first light source 12, the second light source 22, the first homogenizing lens 31 and the second homogenizing lens 32 can be changed to meet specific requirements.

Optionally, the aforementioned first substrate 11 may include a first circuit board, which is electrically connected to the first light source 12; and the second substrate 21 includes a second circuit board, which is electrically connected to the second light source 22.

It should be understood that the first substrate 11 is configured to bear the first light source 12, and the second substrate 21 is configured to bear the second light source 22. The first substrate 11 may be the first circuit board, the second substrate 21 may be the second circuit board, and the corresponding circuit board may supply power to the corresponding light source. The circuit board may be any one of a printed circuit board, a flexible circuit board, and a rigid-flex board, which is not limited here.

Optionally, the first substrate 11 further includes a first reinforcing plate, and the first circuit board is provided between the first reinforcing plate and the first light source 12; and/or, the second substrate 21 further includes a second reinforcing plate, and the second circuit board is provided between the second reinforcing plate and the second light source 22. It should be noted that the first reinforcing plate can be configured to support the first circuit board and the first light source 12, and the second reinforcing plate can be configured to support the second circuit board and the second light source 22, so as to improve the structural stability of the optical module.

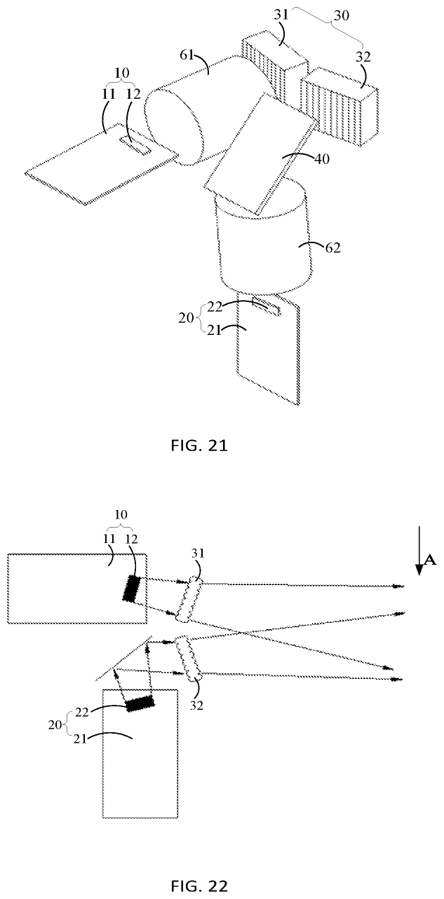

For example, referring to FIG. 20 and FIG. 21 in combination, in this embodiment, the optical module further includes a first compressional mirror 61 and a second compressional mirror 62, the first compressional mirror 61 is provided between the first light emitting assembly 10 and the homogenizing lens group 30 (specifically, the first compressional mirror 61 is provided between the first light emitting assembly 10 and the first homogenizing lens 31); and the second compressional mirror 62 is provided between the second light emitting assembly 20 and the homogenizing lens group 30 (specifically, the second compressional mirror 62 is provided between the second light emitting assembly 20 and the second homogenizing lens 32). The first compressional mirror 61 and the second compressional mirror 62 are respectively configured to compress the corresponding light beams.

It should be noted that the first compressional mirror 61 and the second compressional mirror 62 mainly act in the fast axis direction. For example, the first compressional mirror 61 and the second compressional mirror 62 can be respectively selected from a cylindrical aspheric mirror or a revolving aspheric mirror, and the present disclosure does not specifically limit the forms of the first compressional mirror 61 and the second compressional mirror 62.

Optionally, the optical module further includes at least one third light emitting assembly, and the light beams respectively emitted from the first light emitting assembly 10, the second light emitting assembly 20 and the third light emitting assembly are homogenized and emitted by the homogenizing lens group 30 to form light spot(s).

On the other hand, the invention provides a laser system. The laser system comprises the optical module, and the structure and the beneficial effects of the optical module are described in detail, so that the optical module is not required to be described in detail.

The foregoing are merely alternative embodiments of the invention and are not intended to limit the invention, and various modifications and variations of the invention are intended to be included within the scope of the invention by those skilled in the art, whenever such modifications, equivalents, modifications, and the like are intended to be within the spirit and principles of the invention.

Additionally, it should be noted that the specific features described in the foregoing embodiments may be combined in any suitable manner without contradiction, and that the present invention will not otherwise describe various possible combinations in order to avoid unnecessary repetitio.

What is claimed is:

1. An optical module, comprising a first light emitting assembly, a second light emitting assembly, and a homogenizing lens group provided at light emitting sides of the first light emitting assembly and the second light emitting assembly; and
light beams emitted from the first light emitting assembly and the second light emitting assembly are respectively vertically incident at a light incident side of the homogenizing lens group, and the homogenizing lens group is configured to homogenize and emit the light beams incident by the first light emitting assembly and the second light emitting assembly to form a light spot.

2. The optical module according to claim 1, wherein the homogenizing lens group comprises a first homogenizing lens and a second homogenizing lens arranged in a first direction, wherein the first homogenizing lens is configured to correspondingly receive the light beam emitted from the first light emitting assembly, and the second homogenizing lens is configured to correspondingly receive the light beam emitted from the second light emitting assembly; and the first homogenizing lens and the second homogenizing lens are independent optical elements or formed as an integral molding part.

3. The optical module according to claim 2, wherein the first light emitting assembly comprises a first substrate and a first light source packed on the first substrate; and the second light emitting assembly comprises a second substrate and a second light source packed on the second substrate, a light emitting surface of the first light source and a receiving surface are provided having an included angle therebetween, and a light emitting surface of the second light source and the receiving surface are provided having an included angle therebetween.

4. The optical module according to claim 3, wherein light emitting directions of the first light source and the second light source are both toward the receiving surface, a light emitting side of the first light source is parallel to a light incident side of the first homogenizing lens, and a light emitting side of the second light source is parallel to a light incident side of the second homogenizing lens; or
the light emitting direction of the second light source is not toward the receiving surface, the light emitting side of the first light source is parallel to the light incident side of the first homogenizing lens; and the second light emitting assembly further comprises a reflecting mirror, and the light beam emitted from the second light source is reflected by the reflecting mirror and then incident at the second homogenizing lens.

5. The optical module according to claim 2, wherein the first light emitting assembly comprises a first substrate, a first light source, and a first light transmitting potting body that packs the first light source on the first substrate, wherein the light beam emitted from the first light source is refracted by a surface of the first light transmitting potting body close to the first homogenizing lens and then incident at the first homogenizing lens; and the second light emitting assembly comprises a second substrate, a second light source, and a second light transmitting potting body that packs the second light source on the second substrate, and the light beam emitted from the second light source is refracted by a surface of the second light transmitting potting body close to the second homogenizing lens and then incident at the second homogenizing lens; and
the surface of the first light transmitting potting body close to the first homogenizing lens and a surface of the first light source close to the first homogenizing lens form a first preset included angle; and the surface of the second light transmitting potting body close to the second homogenizing lens and a surface of the second light source close to the second homogenizing lens form a second preset included angle.

6. The optical module according to claim 5, wherein light emitting directions of the first light source and the second light source are both toward a receiving surface; or
the light emitting direction of the second light source is not toward the receiving surface; and the second light emitting assembly further comprises a reflecting mirror, the light beam emitted from the second light source is refracted by a surface of the second light transmitting potting body close to the first homogenizing lens and then incident at the reflecting mirror, and is reflected by the reflecting mirror and then incident at the second homogenizing lens.

7. The optical module according to claim 2, wherein the first light emitting assembly comprises a first substrate and a first light source packed on the first substrate; and the second light emitting assembly comprises a second substrate and a second light source packed on the second substrate; and the first light emitting assembly further comprises a first wedge lens, the second light emitting assembly further comprises a second wedge lens, and the first wedge lens is provided on one side of the first homogenizing lens close to the first light source, and the second wedge lens is provided on one side of the second homogenizing lens close to the second light source.

8. The optical module according to claim 7, wherein light emitting directions of the first light source and the second light source are both toward the receiving surface; or
the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

9. The optical module according to claim 2, wherein the first light emitting assembly comprises a first substrate and a first light source packed on the first substrate, and a light emitting surface of the first light source and a receiving surface are provided having an included angle therebetween; and the second light emitting assembly comprises a second substrate, a second light source, and a second light transmitting potting body that packs the second light source on the second substrate, a surface of the second light transmitting potting body close to the second homogenizing lens and a surface of the second light source close to the second homogenizing lens form a second preset included angle, and the light beam emitted from the second light source is refracted by the surface of the second light transmitting potting body close to the second homogenizing lens and then incident at the second homogenizing lens.

10. The optical module according to claim 9, wherein light emitting directions of the first light source and the second light source are both toward the receiving surface, and a light emitting side of the first light source is parallel to a light incident side of the first homogenizing lens; or
the light emitting direction of the second light source is not toward the receiving surface, the second light emitting assembly further comprises a reflecting mirror, and the light beam emitted from the second light source is refracted by a surface of the second light transmitting potting body close to the first homogenizing lens and then incident at the reflecting mirror, and is reflected by the reflecting mirror and then incident at the second homogenizing lens.

11. The optical module according to claim 2, wherein the first light emitting assembly comprises a first substrate and a first light source packed on the first substrate, and a light emitting surface of the first light source and a receiving surface are provided having an included angle therebetween; and the second light emitting assembly comprises a second substrate, a second light source packed on the second substrate, and a second wedge lens provided on a side of the second homogenizing lens close to the second light source.

12. The optical module according to claim 11, wherein light emitting directions of the first light source and the second light source are both toward the receiving surface, and a light emitting side of the first light source is parallel to a light incident side of the first homogenizing lens; or
the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

13. The optical module according to claim 2, wherein the first light emitting assembly comprises a first substrate, a first light source, and a first light transmitting potting body that packs the first light source on the first substrate, a surface of the first light transmitting potting body close to the first homogenizing lens and a surface of the first light source close to the first homogenizing lens form a first preset included angle, and the light beam emitted from the first light source is refracted by the surface of the first light transmitting potting body close to the first homogenizing lens and then incident at the first homogenizing lens; and the second light emitting assembly comprises a second substrate, a second light source packed on the second substrate, and a second wedge lens provided on a side of the second homogenizing lens close to the second light source.

14. The optical module according to claim 13, wherein light emitting directions of the first light source and the second light source are both toward a receiving surface; or
the light emitting direction of the second light source is not toward the receiving surface; and the second light emitting assembly further comprises a reflecting mirror, and the light beam emitted from the second light source is reflected by the reflecting mirror and then incident at the second wedge lens, and is refracted by the second wedge lens and then incident at the second homogenizing lens.

15. The optical module according to claim 1, wherein the optical module further comprises a first compressional mirror and a second compressional mirror, the first compressional mirror is provided between the first light emitting assembly and the homogenizing lens group, and the second compressional mirror is provided between the second light emitting assembly and the homogenizing lens group.

16. The optical module according to claim 1, wherein the optical module further comprises at least one third light emitting assembly, and light beams respectively emitted from the first light emitting assembly, the second light emitting assembly and the third light emitting assembly are homogenized and emitted by the homogenizing lens group to form a light spot.

17. A laser system, comprising the optical module according to claim 1.
